(19) United States
(12) Patent Application Publication
(10) Pub. No.: US 2026/0303246 A1
(43) Pub. Date: Oct. 1, 2026

(54) CROSS TIMESTAMPING FOR PCI EXPRESS PRECISION TIME MEASUREMENT

(71) Applicant: Microchip Touch Solutions Limited, Wokingham (GB)

(72) Inventor: Richard Jonathan Petrie, Guildford (GB)

(73) Assignee: Microchip Touch Solutions Limited, Wokingham, Berkshire (GB)

(21) Appl. No.: 19/278,698

(22) Filed: Jul. 23, 2025

Related U.S. Application Data
(60) Provisional application No. 63/779,727, filed on Mar. 28, 2025.

(51) Int. Cl. H04J 3/06

(52) U.S. Cl. CPC H04J 3/0667

(57) ABSTRACT

Methods, and apparatuses send a data packet associated with a transmit signal (Tₓ) to a host device, the Tₓ including a request transmission time and causing the host device to generate a timestamp at time T₂, and receive a receiver signal (Rₓ) associated with the data packet from the host device, the Rₓ including a response transmission time, the Rₓ being sent from the host device at time T₃. Based on the T₂ and the request transmission time, a time T₁ of the data packet sent to the host device is determined, and based on the T₃ and the response transmission time, a time T₄ the data packet was received from the host device is determined. A clock phase between a precision time protocol (PTP) and a precision time management (PTM) system is determined and a clock signal of the PTM system is cross timestamped with the PTP.

### CROSS-REFERENCE TO RELATED APPLICATION

The present application claims priority from U.S. Provisional Patent Application No. 63/779,727, filed on Mar. 28, 2025, which is incorporated herein by reference in its entirety.

### TECHNICAL FIELD

The present disclosure relates generally to time stamping for peripheral component interconnect express (PCIe) switches, and more specifically to apparatuses, methods, and a computer readable medium to provide cross timestamping for PCIe switches for precision time measurement (PTM) applications.

### SUMMARY

According to an aspect of one or more examples, there is provided an apparatus to provide precision time management (PTM) facilitating cross timestamping. The system may include a host device and a peripheral component interconnect express (PCIe) switch in communication with the host device. The PCIe switch may send a data packet that may be associated with a transmit signal (Tₓ) to the host device, the Tₓ including a request transmission time, the Tₓ causing the host device to generate a timestamp at time T₂, and receive a receiver signal (Rₓ) associated with the data packet from the host device, the Rₓ including a response transmission time, and the Rₓ may be sent from the host device at time T₃. The request transmission time and the response transmission time may be determined. Based on the T₂ and the request transmission time, a time T₁ that the data packet was sent to the host device may be determined, where T₁ represents a rising edge of a clock signal of a PTM system. Based on the T₃ and the response transmission time, a time T₄ that the data packet was received from the host device may be determined, where T₄ represents a falling edge of the clock signal of the PTM system. The rising edge and the falling edge may be compared to a total propagation delay associated with a precision time protocol (PTP) to determine a clock phase between the PTP and the clock signal of the PTM system. The clock signal of the PTM system may be cross timestamped with the PTP. Further, the T₁, the T₂, the T₃, and the T₄ may be timestamped in nanoseconds.

The data packet may be sent when a PTM frame associated with the PTM system may be detected. Further, latency in the request transmission time and the response transmission time may be fixed. A phase predictor of the PCIe switch may predict a phase relationship between a clock signal of the host device corresponding to the PTM system as well as the transmit signal (Tₓ) and the receiver signal (Rₓ). A prediction of the phase relationship together with identified latency of physical layers of a port of the PCIe switch may be used to adjust a timestamp captured by the PTM to generate a real PTM timestamp to be used in a PTM frame for when the data packet may be sent. The phase predictor may be to transfer a time associated with the PTP from a system clock domain of the host device to a line clock domain of the PCIe switch. The phase predictor may be to perform PTP frame modifications in the line clock domain. The PCIe switch may compensate for frequency drift between the clock signal of the PTM system and the PTP. The PCIe switch may use a resistor-transistor logic (RTL) to perform the compensating.

According to an aspect of one or more examples, there is provided a method to provide precision time management (PTM) facilitating cross timestamping. The method may include sending a data packet that may be associated with a transmit signal (Tₓ) to the host device, the Tₓ including a request transmission time, the Tₓ causing the host device to generate a timestamp at time T₂. The method may also include receiving a receiver signal (Rₓ) associated with the data packet from the host device, the Rₓ including a response transmission time, the Rₓ may be sent from the host device at time T₃. The request transmission time and the response transmission time may be determined. Based on the T₂ and the request transmission time, the method may include determining a time T₁ that the data packet was sent to the host device, where T₁ represents a rising edge of a clock signal of the PTM system. Based on the T₃ and the response transmission time, the method includes determining a time T₄ that the data packet was received from the host device, where T₄ represents a falling edge of the clock signal of the PTM system. The method may also include comparing the rising edge and the falling edge to a total propagation delay associated with a precision time protocol (PTP) to determine a clock phase between the PTP and the clock signal of the PTM system. The method may also include cross timestamping the clock signal of the PTM system with the PTP. Further, the T₁, the T₂, the T₃, and the T₄ may be timestamped in nanoseconds.

The data packet may be sent when a PTM frame associated with the PTM system may be detected. Further, latency in the request transmission time and the response transmission time may be fixed. A phase predictor of a PCIe switch may predict a phase relationship between a clock signal of the host device corresponding to the PTM as well as the transmit signal (Tₓ) and the receiver signal (Rₓ). A prediction of the phase relationship together with identified latency of physical layers of a port of the PCIe switch may be used to adjust a timestamp captured by the PTM to generate a real PTM timestamp to be used in a PTM frame for when the data packet may be sent. The phase predictor may be to transfer a time associated with the PTP from a system clock domain of the host device to a line clock domain of a PCIe switch. The phase predictor may be to perform PTP frame modifications in the line clock domain. A PCIe switch may compensate for frequency drift between the clock signal of the PTM and the PTP. A PCIe switch may use a resistor-transistor logic (RTL) to perform the compensating.

According to an aspect of one or more examples, there is provided non-transitory computer-readable storage medium, the computer-readable storage medium storing instructions that when executed by a processor cause the processor to provide precision time management (PTM) facilitating cross timestamping. The processor may send a data packet that may be associated with a transmit signal (Tₓ) to a host device, where the Tₓ includes a request transmission time, and the Tₓ causes the host device to generate a timestamp at time T₂. The receiver signal (Rₓ) associated with the data packet may be received from the host device, where the Rₓ includes a response transmission time, and the Rₓ may be sent from the host device at time T₃. The request transmission time and the response transmission time may be determined. Based on the T₂ and the request transmission time, a time T₁ that the data packet was sent to the host device may be determined, where T₁ represents a rising edge of a clock signal of a PTM system. Based on the T₃ and the response transmission time, a time T₄ that the data packet was received from the host device may be determined, where T₄ represents a falling edge of the clock signal of the PTM system. The rising edge and the falling edge may be compared to a total propagation delay associated with a precision time protocol (PTP) to determine a clock phase between the PTP and the clock signal of the PTM system. The clock signal of the PTM system may be cross timestamped with the PTP. Further, the T₁, the T₂, the T₃, and the T₄ may be timestamped in nanoseconds.

A phase predictor of the PCIe switch may predict a phase relationship between a clock signal of the host device corresponding to the PTM system as well as the transmit signal (Tₓ) and the receiver signal (Rₓ).

### BRIEF DESCRIPTION OF DRAWINGS

FIG. 1 shows a schematic view of a PCIe switch, according to one or more examples.

FIG. 2 shows a diagram for timing synchronization, according to one or more examples.

FIG. 3 shows a diagram for PTM timestamping, according to one or more examples.

FIG. 4 shows a flowchart illustrating a method for precision time management (PTM) facilitating cross timestamping, according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Phase predictors may be used to predict a phase relationship between two different clocks. Precision accuracy may be important for use in switches such as PCIe data packet switches, particularly in the context of industrial automation applications, telecommunications through cell towers, and various other applications without limitation. To accommodate advancements in certain industrial applications, improvements to PCIe switches may provide enhanced capabilities to apply timestamps in less than a microsecond. Various examples may be used to increase the accuracy and resolution of the predicted phase relationship while also supporting different clock frequencies. For example, an event in a system clock domain may be detected and the phase predictor may subtract the time that has passed since a previous rising clock edge occurred prior to the event, which may allow for a system clock domain to be continuously aware of the previous rising clock edge in the event time domain.

In various examples, phase predictors may detect and predict a phase relationship between different clocks that may be running at different frequencies. For example, the phase predictors may provide continuous phase values between a system clock and a line clock with accuracy at a sub-microsecond level (i.e., a nanosecond level). A phase predictor may implement a PCIe PTM protocol, which may calculate the propagation delay between a downstream requester and an upstream responder. The systems, methods, and apparatuses disclosed herein may provide a more accurate synchronization in sub-microseconds (i.e., nanoseconds), which may be more accurate than previous PTM applications, which may typically be limited to accuracy levels greater than one microsecond. In various examples, the system clock may include a copy of the time from a national timestamp authority.

The phase predictor may include a line clock running in a line clock domain and a system clock running in a system clock domain. The system clock domain may use PTM synchronization to achieve timestamp precision by measuring the time, within microseconds, that a signal may be transmitted and received, which enables the system clocks to account for network delays. The phase predictor may also include a line clock cycle predictor and a phase difference predictor. The line clock cycle predictor may include a line clock counter operating in a line clock domain, a system clock counter operating in the system clock domain, and divider circuitry coupled to both the line clock counter and the system clock counter. However, since the system clock domain may use PTM synchronization in terms of microseconds, the line clock domain for PCIe switches has traditionally been in microseconds rather than sub-microseconds. The systems, methods, and apparatuses disclosed herein may provide greater accuracy to incorporate sub-microsecond (i.e., nanosecond) accuracy.

In various examples, the line clock cycle predictor may make a line clock cycle prediction that may be used to emulate a predicted line clock in the system clock domain. The phase difference predictor may include a phase prediction counter and an alignment detector. The combination of the phase prediction counter and the alignment detector may provide the predicted phase difference between the line clock running in the line clock domain and the system clock running in the system clock domain. This predicted phase difference may be used to adjust a timestamp of a frame in either the line clock domain or the system clock domain.

In various examples, the line clock cycle prediction may be made based on one system clock cycle period and may represent the time from a line clock edge to a previous line clock edge with the line clock cycle prediction being compared with a cycle of a system clock. For example, the system clock counter may count system clock cycles of the system clock and provide an output of a number of system clock cycles, the system clock cycle count, that occur during a period of time and the line clock counter may count line clock cycles of the line clock over the same corresponding period of time, the line clock cycle count. The divider circuitry may divide the resulting line clock cycle count by the system clock cycle count to make the line clock cycle prediction. In various examples, the line clock cycle count prediction may represent a fractional number of line clock cycles that occur during respective cycles of the system clock.

A precision time protocol (PTP), version IEEE 1588, may be used for clock synchronization across networked devices, which may be able to achieve sub-microsecond-level (i.e., a nanosecond level) accuracy. The PTP works by exchanging timestamped messages between the national time authority and various downstream clocks to correct time drift. In particular, the PTP provides more accurate timing rather than the network time protocol, which may be limited to millisecond accuracy. The PTP may incorporate a series of messages that include sync, follow-up, delay request, and delay response. The national time authority may send a sync message with a timestamp that includes the timing data, and the network clocks may reply with a delay response, which allow the network clocks to calculate the network delay and make the appropriate adjustments. The PTP accommodates clock offsets and network-induced latency.

Cross timestamping PTP against a PCIe switch of a PTM system allows for additional accuracy for various application, such as a host personal computer (PC), by considering the last few centimeters connected via a PCIe switch as well as the application loading overhead (e.g., of the host PC itself). The PTP may take the time stamp over Ethernet and the time stamp over PTM, and the two times allow the switch to determine the time and the delay between the host system and the switch. The delay may be accommodated and the PTM time may represent the current time on the switch and the application, such that the host PC may know, based on its own time, what time the Ethernet time was and any delay. Because PTM accuracy has traditionally not been at the same level as PTP accuracy, which means that the cross timestamping may not have been at the accuracy level that would provide the benefit of the PTP accuracy.

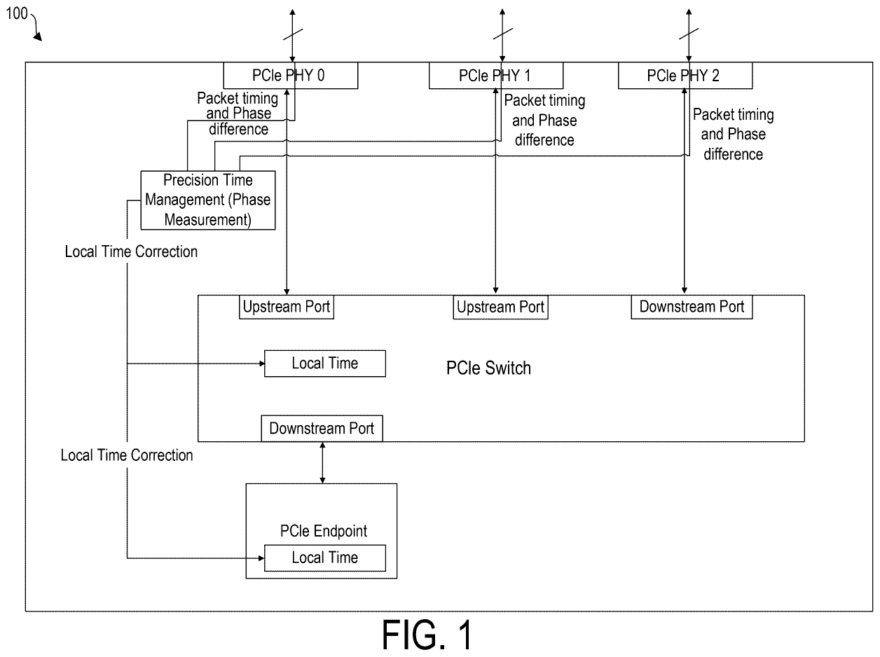

FIG. 1 shows a schematic view of a PCIe switch 100, according to one or more examples. The PCIe switch 100 may include, according to various examples, a twelve-lane PCIe packet switch that may move data from one port to another port. In the embodiment depicted, the PCIe switch 100 is a four-lane PCIe packet switch that includes two upstream ports and two downstream ports. The PCIe switch 100 may include flexible port configurations, peripheral input/output I/O and Ethernet endpoints and port expansion that enable additional peripheral connections. The PCIe switch 100 may also incorporate phase predictor hardware.

The PCIe switch 100 may provide continuous phase values between the system clock and a line clock with high accuracy (nanosecond level). The PCIe switch 100 may incorporate resistor-transistor logic (RTL) and may automatically adjust for frequency fluctuations. The PCIe switch 100 may automatically measure and compensate for frequency drift between clocks that may not be synchronized together. For example, the PCIe switch 100 may utilize a PCIe PTM protocol instead of a PTP protocol.

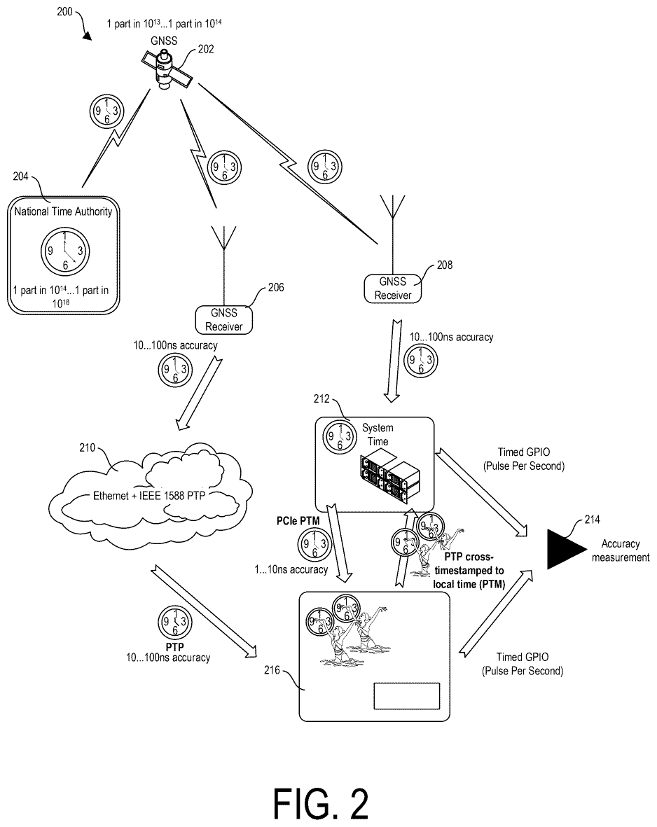

FIG. 2 shows a diagram 200 for timing synchronization, according to one or more examples. A national time authority 204 may utilize an atomic clock that may be in communication with a satellite 202. The satellite 202 replicates the time from the national time authority 204, and the satellite 202 transmits the time down to the global navigation satellite system (GNSS) receiver 208 of the server 212 and the GNSS receiver 206 used by the Ethernet network 210. The PCIe switch 216 may then obtain the PTP time from the Ethernet network 210 and cross-time stamp the PTP time with the system time that may be obtained from the server 212 using PTM. The PCIe switch 216 compares the PTM time from the server 212 with the PTP time from the Ethernet network 210. However, because the PTP may have an accuracy of 10s of nanoseconds in practice and the PTM accuracy may be greater than one microsecond, the times may have different frequencies. To improve the accuracy of the timestamping measurements from microsecond to nanosecond range, the PCIe switch 216 predicts the phase relationship between the PTP and the PTM. This process may use a PCIe PTM protocol for timestamping. This incorporates a modification to PTM protocols by utilizing protocol extensions to include additional propagation delay. The PCIe PTM protocol enables the server 212 and the PCIe switch 216 to both generate a timed general-purpose input/output (GPIO) output that includes a pulse per second (PPS) output signal that may be synchronized to provide an accuracy measurement 214.

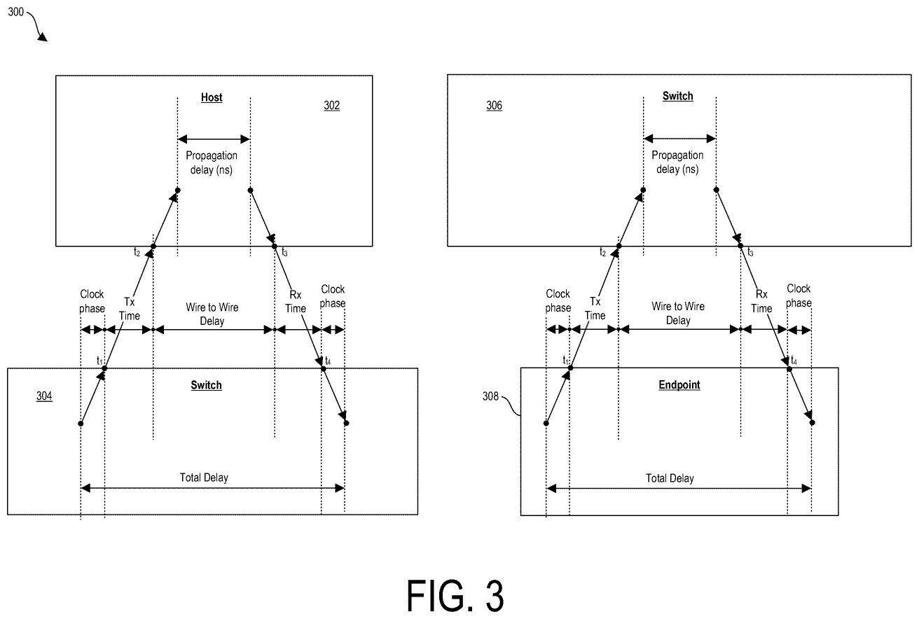

FIG. 3 shows a diagram 300 for PTM timestamping, according to one or more examples. The PCIe switch 304 of the PTM system calculates the propagation delay by initially obtaining a time from the system clock of the upstream host 302. The PCIe switch 304 then calculates the total delay for the time it took the host 302 to respond to the PCIe switch 304. This process may be performed by timestamping at the wire, and this may be used to compare the delay to the time that was thought to be accurate, and then that delay may be used to ascertain the actual time to calculate the timestamp.

PTM logic may generate a receiver signal (R_{X)} and transmit signal (T_{X}) timestamps in the system domain when a PTM frame may be detected. The PTM time reference plane may represent a time when the frame may be passing the connector of the system so there may be a clock domain crossing between the actual time the frame enters/exits the system and the time where the PTM logic generates the R_{X}/T_{X} timestamps. The latency in the R_{X} and T_{X} clock domains in the physical layers of a port (PHY) may be typically fixed or can be predicted by a separate predictor for a given operating mode. The PHY may be responsible for physical transmission of data bits over a medium. The phase predictor results may be used together with the identified latency of the PHY to adjust the timestamp captured by the PTM logic and generate the real PTM timestamp to be used in the PTM frame. In various examples, the phase predictor may be used to transfer the PTP time from the system clock domain to the line clock domain and perform the PTP frame modifications in the line clock domain of the PCIe link layer device for media access control (PCIe MAC). The R_{X} and T_{X} clock phase may be used to measure packet transmission and arrival times, providing accurate timestamping for remote device timing.

T₁ may represent time that the transmit signal Tₓ may be sent from the PCIe switch 304 to the host 302, and T₂ represents the time associated with the time of transmit signal Tₓ itself before it may be received by the host 302. The wire-to-wire delay may represent the delay between the time T₂ when the host 302 receives the transmit signal to the time the host 302 sends out the receiver signal Rₓ at time T₃. The wire-to-wire delay may incorporate the propagation delay (ns) of the host 302. The receiver signal Rₓ may be received by the PCIe switch 304 at time T₄. The total clock delay also accounts for the clock phase that occurs prior to the transmit signal leaving the PCIe switch 304 at T₁ and includes the clock phase that occurs after the receiver signal Rₓ may be received by the PCIe switch 304 at T₄. The clock phase may represent the timing of data sampling or shifting relative to the rising or falling edge of the clock signal.

The PCIe switch 304 measures T₁ and T₄ based on the Rₓ/Tₓ clock rate using the transmitted and received packet sizes. The PCIe switch 304 may timestamp T₂ locally in nanoseconds using analysis of the clock phase. For example, T₂ may be determined by subtracting the transmission time of the request from T₁ (i.e., T₂=T₁−Request transmission time). The PCIe switch 304 may also determine T₄ by adding the transmission time of the response to T₃ (i.e., T₄=T₃+Response transmission time). The host 302 may timestamp T₁ and T₄ locally in nanoseconds using analysis of the clock phase. The host 302 may calculate T₂ and T₃ based on an accurate measurement of the Rₓ/Tₓ clock rate using the transmitted Tₓ and received Rₓ packet sizes. When the host 302 calculates T₂ and T₃, this provides the transmission time for the packets based on the local clock. T₂ may be calculated by the host 302 by adding T₁ to the request transmission time (i.e., T₂=T₁ +Request transmission time), and T₃ may be calculated by subtracting the response transmission time from T₄ (i.e., T₃=T₄−Response transmission time).

Subsequent measurements of T₁′, T₂′, T₃′, and T₄′ may then be used to calculate the PTM master time in accordance with the PCIe specification calculation. Since T₁, T₂, T₃ and T₄ have been measured and calculated in nanoseconds, the local values for these may be a factor of 1,000 that is more accurate than the values reported by the PCIe PTM standard which may be in microseconds. The PCIe may report these more accurate values to the host 302 by various means (e.g., proprietary extensions to the PCIe PTM message or by register access).

Referring now to the PCIe switch 306 and the endpoint 308, a similar process to the one described in reference to the host 302 and the PCIe switch 304 may be performed. T₁ may represent time that the transmit signal Tₓ may be sent from the endpoint 308 to the PCIe switch 306, and T₂ represents the time associated with the time of transmit signal Tₓ itself before it may be received by the PCIe switch 306. The wire-to-wire delay may represent the delay between the time T₂ when the PCIe switch 306 receives the transmit signal to the time the PCIe switch 306 sends out the receiver signal Rₓ at time T₃. The wire-to-wire delay may incorporate the propagation delay (ns) of the PCIe switch 306. The receiver signal Rₓ may be received by the endpoint 308 at time T₄. The total clock delay also accounts for the clock phase that occurs prior to the transmit signal leaving the endpoint 308 at T₁ and includes the clock phase that occurs after the receiver signal Rₓ may be received by the endpoint 308 at T₄.

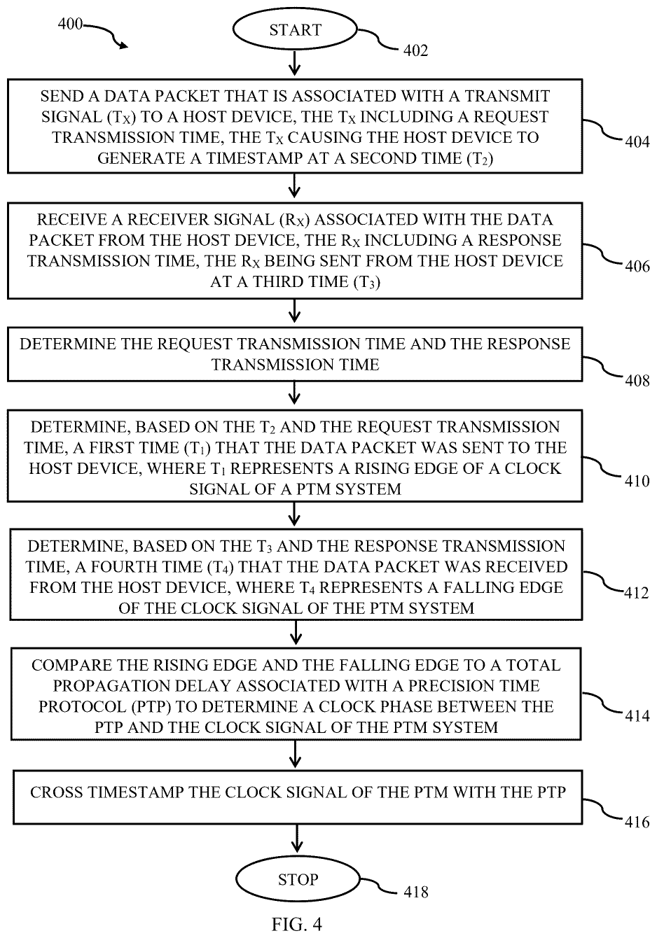

FIG. 4 shows a flowchart 400 illustrating a method for precision time measurement in PCIe switches, according to one or more examples. It may be noted that to explain the method operations of the flowchart 400, references will be made to the elements explained in FIG. 3. The flowchart 400 starts at operation 402. At operation 404, the method may include sending, by a PCIe switch 304, a data packet that is associated with a transmit signal (Tₓ) to a host device 302, the Tₓ including a request transmission time, the Tₓ causing the host device 302 to generate a timestamp at time T₂. At operation 406, the method may include receiving, by the PCIe switch 304, a receiver signal (Rₓ) associated with the data packet from the host device 302, the Rₓ including a response transmission time, the Rₓ being sent from the host device 302 at time T₃. At operation 408, the method may include determining, by the PCIe switch 304, the request transmission time and the response transmission time. At operation 410, the method may include determining, by the PCIe switch 304 and based on the T₂ and the request transmission time, a time T₁ that the data packet was sent to the host device 302, where T₁ represents a rising edge of a clock signal of the PTM system. At operation 412, the method may include determining, by the PCIe switch 304 and based on the T₃ and the response transmission time, a time T₄ that the data packet was received from the host device 302, where T₄ represents a falling edge of the clock signal of the PTM system. At operation 414, the method may include comparing, by the PCIe switch 304, the rising edge and the falling edge to a total propagation delay associated with a precision time protocol (PTP) to determine a clock phase between the PTP and the clock signal of the PTM system. At operation 416, the method may include cross timestamping, by the PCIe switch 304, the clock signal of the PTM system with the PTP. In addition, the T₁, the T₂, the T₃, and the T₄ may be timestamped in nanoseconds. At operation 418, the method may stop.

Various examples have been disclosed herein, in connection with the above description and the drawings. It will be understood that it would be unduly repetitious to literally describe and illustrate all possible combinations or subcombinations of these examples. Accordingly, all examples can be combined in any way or combination, without limitation, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, the accompanying drawings are not to scale. A variety of modifications and variations are possible in light of the above teachings.

What is claimed is:

1. An apparatus for precision time management (PTM) facilitating cross timestamping, the apparatus comprising:
a peripheral component interconnect express (PCIe) switch in communication with a host device, wherein the PCIe switch is to:
send a data packet that is associated with a transmit signal (Tₓ) to the host device, the Tₓ including a request transmission time, the Tₓ causing the host device to generate a timestamp at a second time T₂;
receive a receiver signal (Rₓ) associated with the data packet from the host device, the Rₓ including a response transmission time, the Rₓ being sent from the host device at a third time T₃;
determine the request transmission time and the response transmission time;
determine, based on the T₂ and the request transmission time, a first time T₁ that the data packet was sent to the host device, where T₁ represents a rising edge of a clock signal of a PTM system;
determine, based on the T₃ and the response transmission time, a fourth time T₄ that the data packet was received from the host device, where T₄ represents a falling edge of the clock signal of the PTM system;
compare the rising edge and the falling edge to a total propagation delay associated with a precision time protocol (PTP) to determine a clock phase between the PTP and the clock signal of the PTM system; and
cross timestamp the clock signal of the PTM system with the PTP;
wherein the T₁, the T₂, the T₃, and the T₄ are timestamped in nanoseconds.

2. The apparatus of claim 1, wherein the data packet is to be sent when a PTM frame associated with the PTM system is detected.

3. The apparatus of claim 1, wherein latency in the request transmission time and the response transmission time are fixed.

4. The apparatus of claim 1, wherein a phase predictor of the PCIe switch is to predict a phase relationship between a clock signal of the host device corresponding to the PTM system as well as the transmit signal (Tₓ) and the receiver signal (Rₓ).

5. The apparatus of claim 4, wherein a prediction of the phase relationship and identified latency of physical layers of a port of the PCIe switch are used to adjust a timestamp captured by the PTM system to generate a real PTM timestamp to be used in a PTM frame for when the data packet is sent.

6. The apparatus of claim 4, wherein the phase predictor is to transfer a time associated with the PTP from a system clock domain of the host device to a line clock domain of the PCIe switch.

7. The apparatus of claim 6, wherein the phase predictor is to perform PTP frame modifications in the line clock domain.

8. The apparatus of claim 1, wherein the PCIe switch is to compensate for frequency drift between the clock signal of the PTM system and the PTP.

9. The apparatus of claim 8, wherein the PCIe switch is to use a resistor-transistor logic (RTL) to perform the compensating.

10. A method for precision time management (PTM) facilitating cross timestamping, the method comprising:
sending a data packet that is associated with a transmit signal (Tₓ) to a host device, the Tₓ including a request transmission time, the Tₓ causing the host device to generate a timestamp at a second time T₂;
receiving a receiver signal (Rₓ) associated with the data packet from the host device, the Rₓ including a response transmission time, the Rₓ being sent from the host device at a third time T₃;
determining the request transmission time and the response transmission time;
determining, based on the T₂ and the request transmission time, a first time T₁ that the data packet was sent to the host device, where T₁ represents a rising edge of a clock signal of a PTM system;
determining, based on the T₃ and the response transmission time, a time T₄ that the data packet was received from the host device, where T₄ represents a falling edge of the clock signal of the PTM system;
comparing the rising edge and the falling edge to a total propagation delay associated with a precision time protocol (PTP) to determine a clock phase between the PTP and the clock signal of the PTM system; and
cross timestamping the clock signal of the PTM system with the PTP;
wherein the T₁, the T₂, the T₃, and the T₄ are timestamped in nanoseconds.

11. The method of claim 10, wherein the data packet is to be sent when a PTM frame associated with the PTM system is detected.

12. The method of claim 10, wherein latency in the request transmission time and the response transmission time are fixed.

13. The method of claim 10, wherein a phase predictor of a PCIe switch is to predict a phase relationship between a clock signal of the host device corresponding to the PTM system as well as the transmit signal (Tₓ) and the receiver signal (Rₓ).

14. The method of claim 13, wherein a prediction of the phase relationship and identified latency of physical layers of a port of the PCIe switch are used to adjust a timestamp captured by the PTM system to generate a real PTM timestamp to be used in a PTM frame for when the data packet is sent.

15. The method of claim 13, wherein the phase predictor is to transfer a time associated with the PTP from a system clock domain of the host device to a line clock domain of the PCIe switch.

16. The method of claim 15, wherein the phase predictor is to perform PTP frame modifications in the line clock domain.

17. The method of claim 10, wherein a PCIe switch is to compensate for frequency drift between the clock signal of the PTM system and the PTP.

18. The method of claim 17, wherein the PCIe switch is to use a resistor-transistor logic (RTL) to perform the compensating.

19. A non-transitory computer-readable storage medium, the computer-readable storage medium storing instructions that when executed by a processor cause the processor to:
send a data packet that is associated with a transmit signal (Tₓ) to a host device, the Tₓ including a request transmission time, the Tₓ causing the host device to generate a timestamp at a second time T₂;
receive a receiver signal (Rₓ) associated with the data packet from the host device, the Rₓ including a response transmission time, the Rₓ being sent from the host device at a third time T₃;
determine the request transmission time and the response transmission time;
determine, based on the T₂ and the request transmission time, a first time T₁ that the data packet was sent to the host device, where T₁ represents a rising edge of a clock signal of a precision time management (PTM) system;
determine, based on the T₃ and the response transmission time, a fourth time T₄ that the data packet was received from the host device, where T₄ represents a falling edge of the clock signal of the PTM system;
compare the rising edge and the falling edge to a total propagation delay associated with a precision time protocol (PTP) to determine a clock phase between the PTP and the clock signal of the PTM system; and
cross timestamp the clock signal of the PTM system with the PTP;
wherein the T₁, the T₂, the T₃, and the T₄ are timestamped in nanoseconds.

20. The computer-readable medium of claim 19, wherein the instructions further cause the processor to compensate for frequency drift between the clock signal of the PTM system and the PTP.
